(19) United States
(12) Patent Application Publication
(10) Pub. No.: US 2016/0019818 A1
(43) Pub. Date: Jan. 21, 2016

(54) LISTENING LAB KITS AND METHODS OF MAKING AND USING THE SAME

(71) Applicant: The Corporation of Mercer University, Macon, GA (US)

(72) Inventor: Philip E. Tobin, Lawrenceville, GA (US)

(21) Appl. No.: 14/803,167

(22) Filed: Jul. 20, 2015

Related U.S. Application Data
(60) Provisional application No. 62/026,726, filed on Jul. 21, 2014.

(51) Int. Cl. G09B 23/28; G09B 5/04

(52) U.S. Cl. CPC G09B 23/28; G09B 5/04

(57) ABSTRACT

Listening lab kits are disclosed. Methods of making listening lab kits and methods of using listening lab kits are also disclosed.

### CROSS-REFERENCE TO RELATED APPLICATIONS

This patent application claims the benefit of priority to U.S. provisional patent application Ser. No. 62/026,726 entitled “LISTENING LAB KITS AND METHODS OF MAKING AND USING THE SAME” filed on Jul. 21, 2014, the subject matter of which is incorporated herein in its entirety.

### TECHNICAL FIELD

The present invention relates to listening lab kits. The present invention also relates to methods of making listening lab kits and methods of using listening lab kits.

### BACKGROUND

Current commercially available listening lab kits typically comprise one or more components, such as an artificial cadaver, expensive electronics positioned within and/or outside of the cadaver, and other components. Users can spend $10,000 or more on current commercially available listening lab kits.

What is needed in the art is an inexpensive, effective listening lab kit. Efforts continue to further develop listening lab kits capable of effectively enabling a user (e.g., student) or group of users (e.g., students or medical professionals) to listen to recorded sounds, such as a recording of an actual or artificial heartbeat, via a relatively inexpensive listening lab kit.

### SUMMARY

The present invention addresses some of the difficulties and problems discussed above by the discovery of new listening lab kits.

Accordingly, in one exemplary embodiment, the present invention is directed to listening lab kits. In one exemplary embodiment, the listening lab kit of the present invention comprises: one or more listening devices, each listening device comprising: a tubular member having a first open end and a second end opposite said first open end, a covering material extending over said first open end, a speaker positioned within said tubular member, and one or more electronic components that enable a wired or wireless connection between said speaker and a sound generating device. Typically, the listening lab kit of the present invention comprises two or more listening devices, more typically, from about 4 to about 24 listening devices; however, the listening lab kit of the present invention may comprise any number of listening devices.

In another exemplary embodiment, the listening lab kit of the present invention comprises: (I) two or more listening devices, each listening device comprising: a tubular member having a first open end and a second end opposite said first open end, an individual listening device base or a shared listening device base attached to said second end of said listening device, a covering material extending over said first open end, a speaker positioned within said tubular member, and one or more electronic components that enable a wired or wireless connection between said speaker and a sound generating device; (II) at least one stethoscope; and (III) at least one volume controller positioned between said speaker and a sound generating device, said at least one volume controller being capable of providing an independent volume to each speaker within said listening lab kit.

The present invention is even further directed to methods of making listening lab kits. In one exemplary embodiment, the method of making a listening lab kit comprises: forming one or more listening devices, and for each listening device, said forming step comprising: positioning a speaker within a tubular member having a first open end and a second end opposite the first open end; connecting one or more electronic components to the speaker, the one or more electronic components enabling a wired or wireless connection between the speaker and a sound generating device; and covering the first open end with a covering material that extends over the first open end.

The methods of making a listening lab kit of the present invention may further comprise one or more additional steps, the one or more additional steps including, but not limited to, attaching the speaker to an inner surface of the tubular member; connecting one or more wires so as to extend between the speaker and a sound generating device; drilling at least one hole through a side wall of the tubular member from an exterior to an interior of the tubular member; connecting one or more electronic components that enable a wireless connection between the speaker and a sound generating device (e.g., one or more BLUETOOTH® components); attaching a covering material to the tubular member; and attaching an individual listening device base or a shared listening device base to the second end of the listening device.

The present invention is even further directed to a method of using listening lab kits. In one exemplary embodiment, the method of using a listening lab kit comprises: supplying one or more similar or different sounds to the speaker of at least one listening device within the one or more listening devices.

The methods of using a listening lab kit of the present invention may further comprise one or more additional steps, the one or more additional steps including, but not limited to, supplying one or more similar or different sounds to speakers within two or more listening devices of the listening lab kit; supplying two or more similar or different sounds to speakers within two or more listening devices of the listening lab kit; simultaneously supplying one or more similar or different sounds to speakers within two or more listening devices of the listening lab kit; adjusting a volume of the one or more similar or different sounds; connecting the one or more listening devices to one or more sound generating device; and listening to the one or more similar or different sounds through the covering material.

These and other features and advantages of the present invention will become apparent after a review of the following detailed description of the disclosed embodiments and the appended claims.

### BRIEF DESCRIPTION OF THE FIGURES

FIG. 1 depicts an exemplary listening lab kit of the present invention;

FIG. 2 depicts another exemplary listening lab kit of the present invention;

FIG. 3 depicts a cross-sectional view of an exemplary listening device within the exemplary listening lab kit shown in FIG. 2; and

FIG. 4 photographically depicts an exemplary listening lab kit of the present invention.

### DETAILED DESCRIPTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

The present invention is directed to listening lab kits. The present invention is further directed to methods of making listening lab kits. The present invention is even further directed to methods of using listening lab kits.

The listening lab kits of the present invention and methods of making and using listening lab kits of the present invention are further described in the embodiments below.

Listening Lab Kit Embodiments:

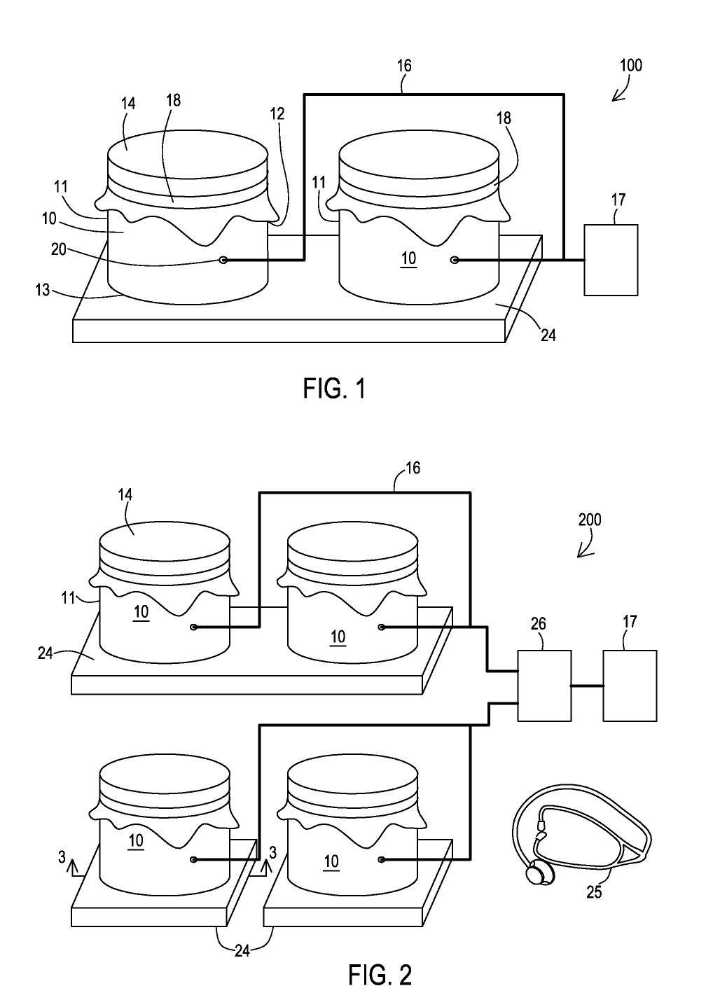

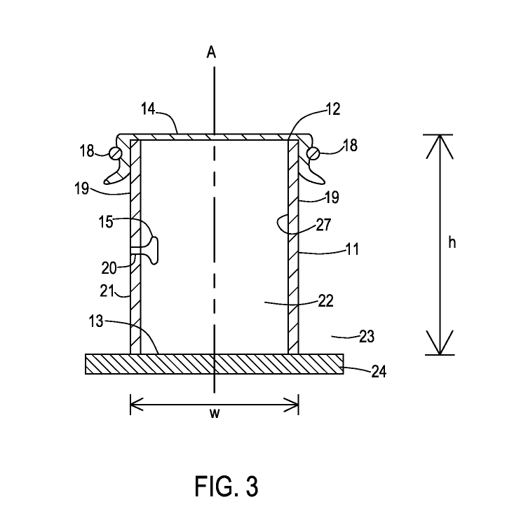

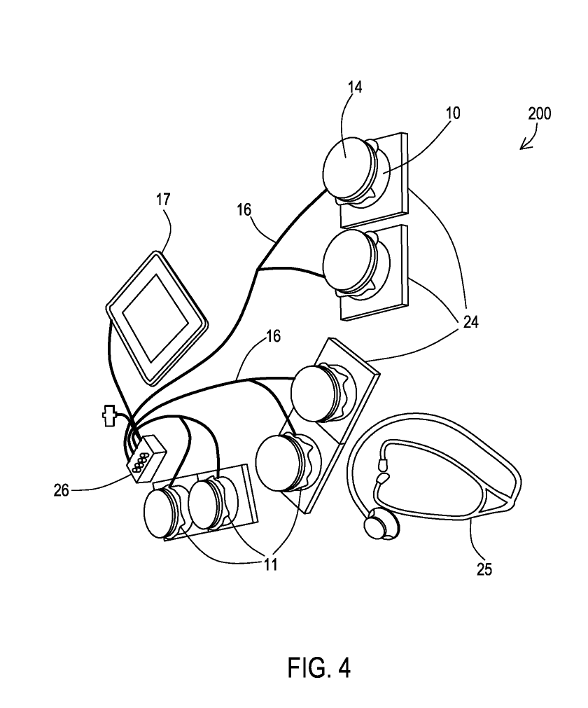

1. A listening lab kit 100/200 comprising: one or more listening devices 10, each listening device 10 comprising: a tubular member 11 having a first open end 12 and a second end 13 opposite said first open end 12, a covering material 14 extending over said first open end 12, a speaker 15 positioned within said tubular member 11, and one or more electronic components 16 that enable a wired or wireless connection between said speaker 15 and a sound generating device 17.
2. The listening lab kit 100/200 of embodiment 1, wherein said second end 13 comprises a second open end 13.
3. The listening lab kit 100/200 of embodiment 1, wherein said second end 13 comprises a closed end 13.
4. The listening lab kit 100/200 of any one of embodiments 1 to 3, wherein said tubular member 11 has a circular cross-sectional area extending perpendicularly to a dissecting line A extending through said first open end 12 and said second end 13. See, dissecting line A shown in FIG. 3. It should be noted that tubular member 11 may have any desired cross-sectional area configuration. For example, tubular member 11 may have any cross-sectional area configuration including, but not limited to, a circular, oval, oblong, triangular, square, rectangular, star, pentagonal, or hexagonal shape extending perpendicularly to dissecting line A.
5. The listening lab kit 100/200 of any one of embodiments 1 to 4, wherein said tubular member 11 comprises a polymeric material. It should be noted that tubular member 11 may be formed from any material including, but not limited to, a polymeric material, a metallic material, a cellulosic material (e.g., wood or paper), a ceramic material, etc. Typically, tubular member 11 comprises a relatively inexpensive polymeric material such as a polyethylene or polypropylene.
6. The listening lab kit 100/200 of any one of embodiments 1 to 5, wherein said tubular member 11 has an overall height h ranging from about 1.0 inch (in) to about 12.0 in, and an overall width w of from about 2.0 in to about 12.0 in. It should be noted that tubular member 11 may have any desired dimensions. Typically, tubular member 11 has an overall height h ranging from about 1.0 in to about 12.0 in (or any height value between 1.0 in and 12.0 in, in increments of 0.1 in, e.g., 4.5 in, or any range of height values between 1.0 in and 12.0 in, in increments of 0.1 in, e.g., from about 4.2 in to about 6.3 in). Typically, tubular member 11 has an overall width w ranging from about 2.0 in to about 12.0 in (or any width value between 2.0 in and 12.0 in, in increments of 0.1 in, e.g., 3.5 in, or any range of width values between 2.0 in and 12.0 in, in increments of 0.1 in, e.g., from about 4.5 in to about 6.5 in).
7. The listening lab kit 100/200 of any one of embodiments 1 to 6, wherein said covering material 14 is attached to said tubular member 11. Covering material 14 may be temporarily or permanently attached to tubular member 11. As used herein, “temporarily attached” refers to embodiments in which covering material 14 is removable from tubular member 11 without damaging or disfiguring covering material 14 and/or tubular member 11 (e.g., use of an elastic band to attach covering material 14 to tubular member 11 as shown in FIGS. 1-4). As used herein, “permanently attached” refers to embodiments in which covering material 14 is not easily removable from tubular member 11, and removal of covering material 14 typically causes damage to covering material 14 and/or tubular member 11 (e.g., an embodiment wherein covering material 14 is adhesively attached to tubular member 11 or thermoformed onto tubular member 11, e.g., via an injection molding step).
8. The listening lab kit 100/200 of any one of embodiments 1 to 7, wherein said covering material 14 is attached to said tubular member 11 via a mechanical fastener 18.
9. The listening lab kit 100/200 of any one of embodiments 1 to 8, wherein said covering material 14 is attached to said tubular member 11 via a mechanical fastener 18, said mechanical fastener 18 comprising an elastic band 18 (e.g., a rubber band) sized to extend along an outer periphery 19 of said tubular member 11 (i.e., along an outer periphery 19 of said tubular member 11 such that covering material 14 is positioned between elastic band 18 and outer periphery 19 of tubular member 11).
10. The listening lab kit 100/200 of any one of embodiments 1 to 9, wherein said covering material 14 comprises a fabric, a film material, or a skin-like material (e.g., leather). Suitable materials for forming covering material 14 include, but are not limited to, woven, nonwoven and knit fabrics, polymeric film material, a skin-like material such as leather, artificial leather, etc., paper, or any combination thereof.
11. The listening lab kit 100/200 of any one of embodiments 1 to 10, wherein said speaker 15 is positioned proximate said second end 13 of said tubular member 11. It should be noted that speaker 15 may be positioned at any location within tubular member 11.
12. The listening lab kit 100/200 of any one of embodiments 1 to 11, wherein said one or more electronic components 16 comprise one or more wires 16 extending between said speaker 15 and a sound generating device 17.
13. The listening lab kit 100/200 of embodiment 12, wherein said tubular member 11 further comprises at least one hole 20 extending through a side wall 21 of said tubular member 11 from an interior 22 to an exterior 23 of said tubular member 11. In other embodiments, one or more wires 16, when present, may extend through second end 13 and/or an individual listening device base 24 or a shared listening device base 24 attached to second end 13 of listening device 10.
14. The listening lab kit 100/200 of any one of embodiments 1 to 11, wherein said one or more electronic components 16 comprise one or more electronic components (not shown) that enable a wireless connection between said speaker 15 and a sound generating device 17 (e.g., one or more BLUETOOTH® components). For example, speaker 15 may utilize one or more electronic components that enable BLUETOOTH® technology between speaker 15 and a sound generating device 17, such as a mobile phone.
15. The listening lab kit 100/200 of any one of embodiments 1 to 14, wherein said listening lab kit 100/200 comprises two or more of said listening devices 10.
16. The listening lab kit 100/200 of any one of embodiments 1 to 15, wherein said listening lab kit 100/200 comprises from 2 to 24 of said listening devices 10.
17. The listening lab kit 100/200 of any one of embodiments 1 to 16, wherein each listening device 10 comprises an individual listening device base 24 or a shared listening device base 24 attached to said second end 13 of said listening device 10. Like tubular member 11, each individual listening device base 24 or shared listening device base 24 may be formed from any material including, but not limited to, a polymeric material, a metallic material, a cellulosic material (e.g., wood or paper), a ceramic material, etc. Typically, each individual listening device base 24 or shared listening device base 24 comprises a relatively inexpensive polymeric material such as a polyethylene or polypropylene. Further, it should be noted that in some embodiments, each individual listening device base 24 or shared listening device base 24 is integrally attached to one or more listening devices 10 (e.g., a given individual listening device base 24 and a given listening device 10 are thermoformed (e.g., molded) as a single molded piece). In other embodiments, a given individual listening device base 24 and a separate listening device 10 may be attached to one another via an adhesive and/or a mechanical fastener (e.g., one or more screws).
18. The listening lab kit 100/200 of any one of embodiments 1 to 17, wherein each listening device 10 comprises an individual listening device base 24 attached to said second end 13 of said listening device 10.
19. The listening lab kit 100/200 of any one of embodiments 1 to 18, wherein said listening lab kit 100/200 further comprises: at least one stethoscope 25.
20. The listening lab kit 100/200 of any one of embodiments 1 to 19, wherein said listening lab kit 100/200 further comprises: one stethoscope 25 for each listening device 10.
21. The listening lab kit 100/200 of any one of embodiments 1 to 20, wherein said listening lab kit 100/200 further comprises: at least one sound generating device 17. Suitable sound generating devices 17 include, but are not limited to, a mobile phone, a tablet, a laptop, a mobile sound system (e.g., an iPOD™ device), a personal computer, a stereo system, a home surround sound system, etc.
22. The listening lab kit 100/200 of any one of embodiments 1 to 21, wherein said listening lab kit 100/200 further comprises: two or more sound generating devices 17.
23. The listening lab kit 100/200 of embodiment 21 or 22, wherein at least one sound generating device 17 further comprises one or more sound recordings thereon.
24. The listening lab kit 100/200 of embodiment 23, wherein said one or more sound recordings comprise one or more (i) heartbeat recordings or (ii) simulated heartbeat recordings.
25. The listening lab kit 100/200 of any one of embodiments 21 to 24, wherein said listening lab kit 100/200 further comprises: at least one volume controller 26 positioned between said speaker 15 and said at least one sound generating device 17, said at least one volume controller 26 being capable of providing an independent volume to each speaker 15 within said listening lab kit 100/200.
26. A listening lab kit 100/200 comprising: (I) two or more listening devices 10, each listening device 10 comprising: a tubular member 11 having a first open end 12 and a second end 13 opposite said first open end 12, an individual listening device base 24 or a shared listening device base 24 attached to said second end 13 of said listening device 10, a covering material 14 extending over said first open end 12, a speaker 15 positioned within said tubular member 11, and one or more electronic components 16 that enable a wired or wireless connection between said speaker 15 and a sound generating device 17; (II) at least one stethoscope 25; and (III) at least one volume controller 26 positioned between said speaker 15 and a sound generating device 17, said at least one volume controller 26 being capable of providing an independent volume to each speaker 15 within said listening lab kit 100/200.

Methods of Making Listening Lab Kit Embodiments:

27. A method of making the listening lab kit 100/200 of any one of embodiments 1 to 26, said method comprising: forming one or more listening devices 10, and for each listening device 10, said forming step comprising: positioning a speaker 15 within a tubular member 11 having a first open end 12 and a second end 13 opposite the first open end 12; connecting one or more electronic components 16 to the speaker 15, the one or more electronic components 16 enabling a wired or wireless connection between the speaker 15 and a sound generating device 17; and covering the first open end 12 with a covering material 14 that extends over the first open end 12.
28. The method of embodiment 27, wherein said positioning step comprises attaching the speaker 15 to an inner surface 27 of the tubular member 11. As discussed above, speaker 15 may be positioned at any location within tubular member 11. In embodiments wherein speaker 15 is positioned at a central location within tubular member 11 (i.e., along dissecting line A), one or more bracing members (not shown) may be used to mount speaker 15 at a central/center location within tubular member 11. Further, it should be noted (although not shown) that a given listening device 10 may comprise two or more speakers 15 within a single tubular member 11 with each speaker 15 connected to the same sound generating device 17 or, alternatively, each speaker 15 connected to a different sound generating device 17.
29. The method of embodiment 27 or 28, wherein said connecting step comprises connecting one or more wires 16 so as to extend between the speaker 15 and a sound generating device 17.
30. The method of any one of embodiments 27 to 29, wherein said method further comprises drilling at least one hole 20 through a side wall 21 of the tubular member 11 from an exterior 23 to an interior 22 of the tubular member 11. As noted above, in an alternative embodiment, the method may comprise drilling at least one hole (not shown) through individual listening device base 24 or shared listening device base 24 to accommodate one or more wires 16.
31. The method of embodiment 27 or 28, wherein said connecting step comprises connecting one or more electronic components (not shown) that enable a wireless connection between the speaker 15 and a sound generating device 17 (e.g., one or more BLUETOOTH® components). The one or more wireless components may be mounted within tubular member 11 along with speaker 15.
32. The method of any one of embodiments 27 to 31, wherein said covering step comprises attaching a covering material 14 to the tubular member 11.
33. The method of any one of embodiments 27 to 32, wherein said covering step comprises attaching a covering material 14 to the tubular member 11 via a mechanical fastener 18.
34. The method of any one of embodiments 27 to 33, wherein said covering step comprises attaching a covering material 14 to the tubular member 11 via a mechanical fastener 18, the mechanical fastener 18 comprising an elastic band 18 sized to extend along an outer periphery 19 of the tubular member 11.
35. The method of any one of embodiments 27 to 34, wherein said forming step further comprises attaching an individual listening device base 24 or a shared listening device base 24 to the second end 13 of the listening device 10.
36. The method of any one of embodiments 27 to 35, wherein said forming step further comprises attaching an individual listening device base 24 to the second end 13 of the listening device 10.
37. The method of any one of embodiments 27 to 36, wherein said forming step comprises forming two or more of the listening devices 10.
38. The method of any one of embodiments 27 to 37, wherein said forming step comprises forming from 2 to 24 of the listening devices 10.
39. The method of any one of embodiments 27 to 38, further comprising: providing at least one stethoscope 25.
40. The method of any one of embodiments 27 to 39, further comprising: providing one stethoscope 25 for each listening device 10.
41. The method of any one of embodiments 27 to 40, further comprising: providing one or more sound recordings suitable for use on a sound generating device 17.
42. The method of embodiment 41, wherein the one or more sound recordings comprise one or more (i) heartbeat recordings or (ii) simulated heartbeat recordings.
43. The method of any one of embodiments 27 to 42, further comprising: providing at least one sound generating device 17.
44. The method of any one of embodiments 27 to 43, further comprising: providing two or more sound generating devices 17.
45. The method of any one of embodiments 27 to 44, further comprising: providing at least one volume controller 26 positionable between the speaker 15 and at least one sound generating device 17, the at least one volume controller 26 being capable of providing an independent volume to each speaker 15 within the listening lab kit 100/200.

Methods of Using Listening Lab Kit Embodiments:

46. A method of using the listening lab kit 100/200 of any one of embodiments 1 to 26, said method comprising: supplying one or more similar or different sounds to the speaker 15 of at least one listening device 10 within the one or more listening devices 10.
47. The method of embodiment 46, wherein said supplying step comprises: supplying one or more similar or different sounds to speakers 15 within two or more listening devices 10 of the listening lab kit 100/200.
48. The method of embodiment 46 or 47, wherein said supplying step comprises: supplying two or more similar or different sounds to speakers 15 within two or more listening devices 10 of the listening lab kit 100/200.
49. The method of any one of embodiments 46 to 48, wherein said supplying step comprises: simultaneously supplying one or more similar or different sounds to speakers 15 within two or more listening devices 10 of the listening lab kit 100/200.
50. The method of any one of embodiments 46 to 49, wherein said supplying step comprises: simultaneously supplying one or more similar or different sounds to speakers 15 within up to 24 listening devices 10 of the listening lab kit 100/200.
51. The method of any one of embodiments 46 to 50, wherein the one or more similar or different sounds comprise one or more (i) heartbeat recordings or (ii) simulated heartbeat recordings.
52. The method of any one of embodiments 46 to 51, said method further comprising: adjusting a volume of the one or more similar or different sounds.
53. The method of any one of embodiments 46 to 52, said method further comprising: independently adjusting a volume of the one or more similar or different sounds emitted from two or more speakers 15.
54. The method of any one of embodiments 46 to 53, wherein said supplying step comprises: connecting the one or more listening devices 10 to one or more sound generating devices 17.
55. The method of embodiment 54, wherein the one or more sound generating devices 17 comprise a portable electronic device 17 (e.g., a mobile phone, a tablet, a laptop, etc.).
56. The method of any one of embodiments 46 to 55, said method further comprising: listening to the one or more similar or different sounds through the covering material 14.
57. The method of any one of embodiments 46 to 56, said method further comprising: listening to the one or more similar or different sounds through the covering material 14 via one or more stethoscopes 25.
58. The method of any one of embodiments 46 to 57, said method further comprising: evaluating students with regard to a given student's ability to recognize the one or more similar or different sounds through the covering material 14 via a stethoscope 25.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### Examples

Listening lab kits similar to those shown in FIGS. 1-4 were prepared.

It should be understood that although the above-described listening lab kits and/or methods are described as “comprising” one or more components or steps, the above-described listening lab kits and/or methods may “comprise,” “consists of,” or “consist essentially of” the above-described components, features or steps of the listening lab kits and/or methods. Consequently, where the present invention, or a portion thereof, has been described with an open-ended term such as “comprising,” it should be readily understood that (unless otherwise stated) the description of the present invention, or the portion thereof, should also be interpreted to describe the present invention, or a portion thereof, using the terms “consisting essentially of” or “consisting of” or variations thereof as discussed below.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a listening lab kit and/or method that “comprises” a list of elements (e.g., components, features, or steps) is not necessarily limited to only those elements (or components or steps), but may include other elements (or components or steps) not expressly listed or inherent to the listening lab kit and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a listening lab kit and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Further, it should be understood that the herein-described listening lab kits and/or methods may comprise, consist essentially of, or consist of any of the herein-described components, features and steps, as shown in the figures with or without any feature(s) not shown in the figures. In other words, in some embodiments, the listening lab kits and/or methods of the present invention do not have any additional features other than those shown in the figures, and such additional features, not shown in the figures, are specifically excluded from the listening lab kits and/or methods. In other embodiments, the listening lab kits and/or methods of the present invention do have one or more additional features that are not shown in the figures.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A listening lab kit comprising:
one or more listening devices, each listening device comprising:
a tubular member having a first open end and a second end opposite said first open end,
a covering material extending over said first open end,
a speaker positioned within said tubular member, and
one or more electronic components that enable a wired or wireless connection between said speaker and a sound generating device.

2. The listening lab kit of claim 1, wherein said second end comprises a second open end.

3. The listening lab kit of claim 1, wherein said second end comprises a closed end.

4. The listening lab kit of claim 1, wherein said tubular member has a circular cross-sectional area extending perpendicularly to a dissecting line extending through said first open end and said second end.

5. The listening lab kit of claim 1, wherein said tubular member comprises a polymeric material, and has an overall height ranging from about 1.0 inch (in) to about 12.0 in, and an overall width of from about 2.0 in to about 12.0 in.

6. The listening lab kit of claim 1, wherein said covering material is attached to said tubular member.

7. The listening lab kit of claim 6, wherein said covering material is attached to said tubular member via a mechanical fastener, said mechanical fastener comprising an elastic band sized to extend along an outer periphery of said tubular member.

8. The listening lab kit of claim 1, wherein said covering material comprises a fabric, a film material, or a skin-like material.

9. The listening lab kit of claim 1, wherein said speaker is positioned proximate said second end of said tubular member.

10. The listening lab kit of claim 1, wherein said one or more electronic components comprise one or more wires extending between said speaker and a sound generating device.

11. The listening lab kit of claim 1, wherein said one or more electronic components comprise one or more electronic components that enable a wireless connection between said speaker and a sound generating device.

12. The listening lab kit of claim 1, wherein said listening lab kit comprises two or more of said listening devices.

13. The listening lab kit of claim 1, wherein said listening lab kit comprises from 2 to 24 of said listening devices.

14. The listening lab kit of claim 1, wherein each listening device comprises an individual listening device base or a shared listening device base attached to said second end of said listening device.

15. The listening lab kit of claim 1, wherein said listening lab kit further comprises:
one stethoscope for each listening device.

16. The listening lab kit of claim 1, wherein said listening lab kit further comprises:
at least one sound generating device.

17. The listening lab kit of claim 16, wherein at least one sound generating device further comprises one or more sound recordings thereon, wherein said one or more sound recordings comprise one or more (i) heartbeat recordings or (ii) simulated heartbeat recordings.

18. The listening lab kit of claim 16, wherein said listening lab kit further comprises:
at least one volume controller positioned between said speaker and said at least one sound generating device, said at least one volume controller being capable of providing an independent volume to each speaker within said listening lab kit.

19. A listening lab kit comprising:
two or more listening devices, each listening device comprising:
a tubular member having a first open end and a second end opposite said first open end,
an individual listening device base or a shared listening device base attached to said second end of said listening device,
a covering material extending over said first open end,
a speaker positioned within said tubular member, and
one or more electronic components that enable a wired or wireless connection between said speaker and a sound generating device;
at least one stethoscope; and
at least one volume controller positioned between said speaker and a sound generating device, said at least one volume controller being capable of providing an independent volume to each speaker within said listening lab kit.

20. A method of using the listening lab kit of claim 19, said method comprising:
simultaneously supplying one or more similar or different sounds to speakers within the two or more listening devices of the listening lab kit, wherein the one or more similar or different sounds comprise one or more (i) heartbeat recordings or (ii) simulated heartbeat recordings.
